(19) United States
(12) Patent Application Publication
(10) Pub. No.: US 2008/0183787 A1
(43) Pub. Date: Jul. 31, 2008

(54) METHOD FOR MANUFACTURING SERIAL NUMBERS FOR INTEGRATED CIRCUITS

(76) Inventors: Zhengxian ZOU, Chengdu (CN); Ning XIAO, Chengdu (CN); Guojun ZHU, Chengdu (CN)

Correspondence Address: MATTHIAS SCHOLL, 14781 MEMORIAL DRIVE, SUITE 1319, HOUSTON, TX, 77079, US

(21) Appl. No.: 12/018,318

(22) Filed: Jan. 23, 2008

(30) Foreign Application Priority Data
Jan. 26, 2007 (CN) 200710048343.5

(51) Int. Cl. G06F 7/58

(52) U.S. Cl. 708/250

(57) ABSTRACT

The existence of physicochemical variables in semiconductor components, such as the edge effect, the ion implantation, the surface state effect, and the variation in charge carrier mobility, is exploited in a method for manufacturing random serial number for integrated circuits. The physicochemical variables are measured with a high gain amplification circuit and then converted into digital signal. Owing to the randomness of variation of the measured physicochemical variables in semiconductor components, multiple random serial numbers are generated by using multiple amplification circuit units.

### CROSS-REFERENCE TO RELATED APPLICATIONS

This application claims priority benefits to Chinese Patent Application No. 200710048343.5, filed on Jan. 26, 2007, the contents of which are incorporated herein by reference.

### BACKGROUND OF THE INVENTION

1. Field of the Invention

This invention relates to the field of electronic information technology and more particularly to a method for generating random serial numbers for integrated circuits, suitable, e.g., for application in integrated circuit password protection.

2. Description of the Related Art

Almost all integrated circuits produced nowadays are numbered with a unique serial identifier. This is done for a variety of reasons, including information safety. The serial numbers are permanently associated with the integrated circuits by high-temperature fusing or programming. However, this method not only increases the overall cost of integrated circuits, but does not also assure a uniqueness of the serial number and leads to a lower information safety of electronic products.

### SUMMARY OF THE INVENTION

Therefore, it is one objective of the present invention to provide a method for generating a random serial number for an integrated circuit. Compared with the existing technology, the method of the present invention can not only decrease largely the overall cost of the integrated circuit to a large extent, but also ensure the uniqueness of the serial number.

In certain embodiments of the invention, the absence of manual operation ensures information safety of electronic products comprising an integrated circuit with a serial number manufactured according to methods of this invention.

In certain embodiments of the present invention, the method for manufacturing a random serial number for an integrated circuit comprises:

a) inspecting a plurality of positions on a semiconductor component used for manufacturing an integrated circuit each with a separate inspection circuit;

b) obtaining for each position of the semiconductor component an electrical signal based on one or more physicochemical characteristic of the semiconductor component at that position;

c) amplifying each electrical signal with a separate amplification circuit to yield a plurality of amplified electrical signals;

d) processing each amplified electrical signal with a separate signal processor to yield a plurality of digital signals; and

e) merging the plurality of digital signals into a random serial number for an integrated circuit.

### BRIEF DESCRIPTION OF THE DRAWINGS

FIG. 1 illustrates a generation method of a binary digital signal according to one embodiment of the invention; and

FIG. 2 illustrates a generation method of a random serial number according to one embodiment of the invention.

### DETAILED DESCRIPTION OF THE EMBODIMENTS

This invention will hereinafter be described further according to the embodiments.

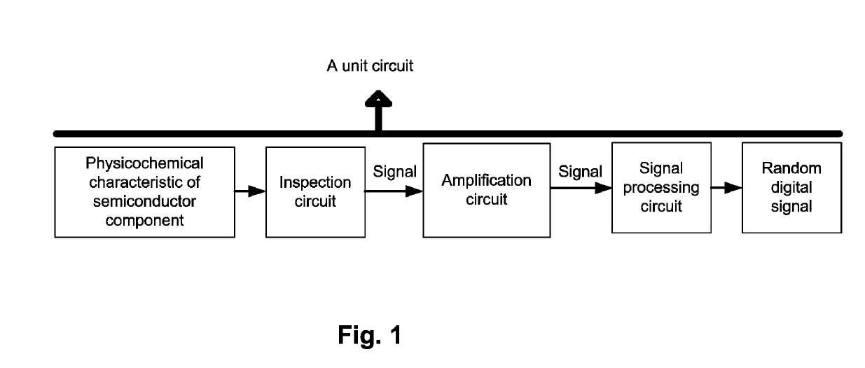

FIG. 1 illustrates the principle of generating binary random digital signal according to one embodiment of the present invention. As shown, a unit circuit comprises an inspection circuit comprising a semiconductor material for inspecting physicochemical characteristics of semiconductor components; an amplification circuit, and signal process circuit.

Regarding to each unit circuit, the existence of non-uniform distribution of physicochemical characteristics associated with such phenomena as, e.g., the edge effect, the ion implantation, the surface state effect, the charge carrier mobility, and so on, results in incompatibilities of semiconductor components. The method according to the invention relies on exploiting these incompatibilities, and comprises inspecting the incompatibilities with an inspection circuit; inputting the inspected signal to a calculation amplifier, in which a weak input offset voltage is generated; amplifying the offset voltage with a high gain amplifier; digitally processing the amplified signal through the signal process circuit to obtain a digital signal. In accordance with this method, one unit circuit generates one random digital signal.

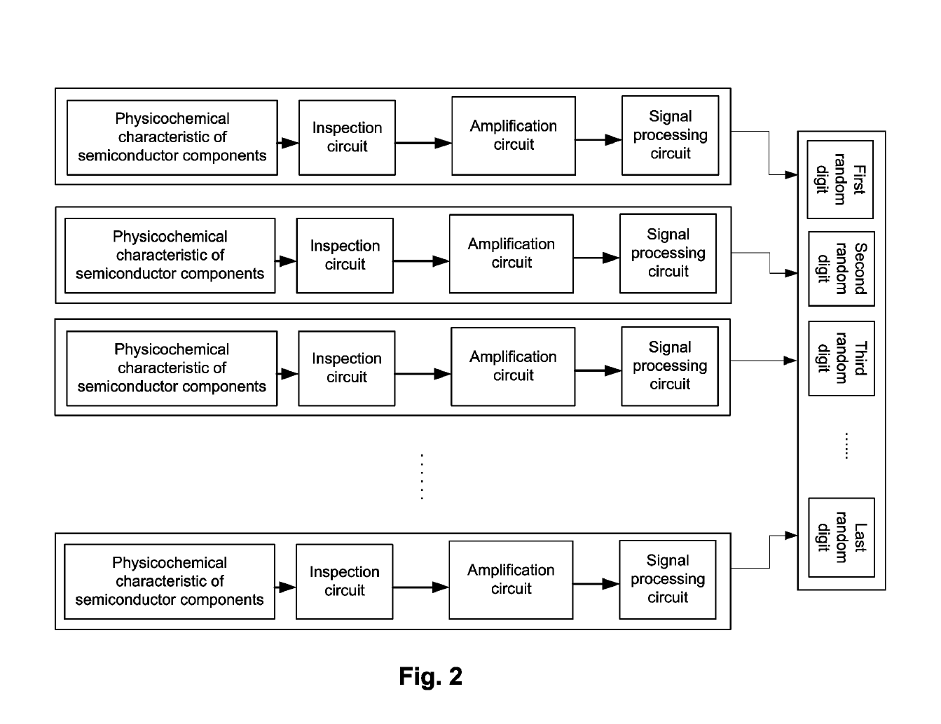

FIG. 2 illustrates a principle of generating multiple random digital signals, namely, a random serial number, according to one embodiment of the invention. The circuit for generating multiple integrated circuit serial numbers comprises a plurality of binary random signal generation unit circuits as shown in FIG. 1. Each unit circuit generates one random digital signal. Each unit is disposed at a different position on the integrated circuit board to ensure that each random digit generation circuit is not related to the others in the same integrated circuit. Therefore, the offset voltages of each unit circuit are different and unpredictable, so that multiple units can generate multiple random digital signals, namely, a random serial number. Since the compatibility characteristics of different integrated circuits are unrelated, different serial numbers can be generated for different integrated circuits.

Although the present invention has been described in connection with preferred embodiments thereof, it will be appreciated by those skilled in the art that additions, modifications, substitutions and deletions not specifically described may be made without departing from spirit and scope of the invention as defined in the claims.

What is claimed is:

1. A method for manufacturing a serial number for an integrated circuit, comprising:
a) inspecting a plurality of positions on a semiconductor component used for manufacturing an integrated circuit each with a separate inspection circuit;
b) obtaining for each position of the semiconductor component an electrical signal based on one or more physicochemical characteristic of the semiconductor component at that position;
c) amplifying each electrical signal with a separate amplification circuit to yield a plurality of amplified electrical signals;
d) processing each amplified electrical signal with a separate signal processor to yield a plurality of digital signals; and
e) merging the plurality of digital signals into a random serial number for an integrated circuit.

2. The method of claim 1, wherein the variability in physicochemical characteristics of the semiconductor components is generated randomly in the manufacturing process of the semiconductor components.

3. The method of claim 1, wherein said amplification circuit is a high-gain amplification circuit.

4. The method of claim 1, wherein the output electrical signal of said amplification circuit is converted into a digital signal by the signal process circuit.

5. The method of claim 1, wherein
a random digital signal generation unit comprises an inspection circuit, an amplification circuit, and a signal processor, and
a circuit for generating random serial number comprises a plurality of random digital signal generation units.

6. The method of claim 5, wherein each random digital signal generation unit is disposed at a different position in the integrated circuit.

7. The method of claim 1, wherein the physicochemical characteristic are related to one or more of the following: edge effect, ion implantation, surface state effect, and charge carrier mobility
